(19) United States
(12) Patent Application Publication
(10) Pub. No.: US 2003/0002902 A1
(43) Pub. Date: Jan. 2, 2003

(54) Keyboard with track operation key

(76) Inventor: Li-Ling Li, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/893,283

(22) Filed: Jun. 28, 2001

(51) Int. Cl. G09G 5/08; G09G 5/00

(52) U.S. Cl. 400/478

(57) ABSTRACT

This invention relates to a keyboards with a track operation key, comprising a track located at a proper position of the keyboard. In the track, there is an operation key that can move along the track, and there is also a sensor used to detect the displacement of the operation key and then converting to the motion displacement value that can control the curser movement on the screen. Therefore, through moving the operation key in the track it becomes feasible to control the cursor's motion directly. For the track and the operation key, they can be set in vertical or horizontal so as to operate the cursor vertically or horizontally.

### BACKGROUND OF THE INVENTION

1. Field of the Invention

This invention relates to a keyboard with a track operation key, particularly a track that has an operation key located in the keyboard, to control the displacement of the cursor by moving the operation key in the track.

2. Background of the Invention

Conventional keyboards used on computers is to input data to files. Since windows have been widely used in personal computers, every computer has had a mouse to control the movement of the cursor. There is a kind of mouse with a rolling ball on the bottom. Through moving the mouse deriving a relative movement of the rolling ball, the cursor is controlled to move on the screen. Another kind of mouse is provided with a rolling axis implemented the center of the mouse. The cursor movement is controlled by the rolling axis.

Obviously, mouse and keyboards are individual devices. In practical operation, it is needed to move the hand from the keyboard to the mouse, and even is needed to reach the mouse and the cursor's position. Therefore, the operation speed will be decreased significantly.

However, most modern keyboard designs has leaded to multimedia keyboard. It means that adding extra keys on the keyboards makes the application on the Internet and MP3 feasible. However, there has not been a designation of keyboard with a cursor controller implemented, so that a keyboard with a track operation key is designed to make the keyboard more efficiency.

A main object of this invention is to provide a keyboard implemented with a track operation key locating in a proper position on the keyboard. In the track, there is an operation key that can move along the track and a sensor that can detect the motion of the operation key along the track that can be converted into the displacement of the cursor of the screen. Therefore, the movement of the cursor can be controlled directly through moving the operation key in the track.

For the keyboard with a track operation key of the invention, the track and the operation key can be set vertically to control the moving of the cursor vertically. They can also be set horizontally to control the moving of the cursor horizontally. If the track and the operation key are set vertically and horizontally simultaneously, the moving of the cursor can be controlled vertically and horizontally.

### BRIEF DESCRIPTION OF THE DRAWINGS

FIG. 1 is a perspective view of a keyboard with a track operation key of the invention, showing the track and the operation key set horizontally.

FIG.2 is a perspective view of another embodiment of the invention, showing the track and the operation key set vertically and horizontally simultaneously.

### DETAILED DESCRIPTION OF THE PREFERRED EMBODIMENTS

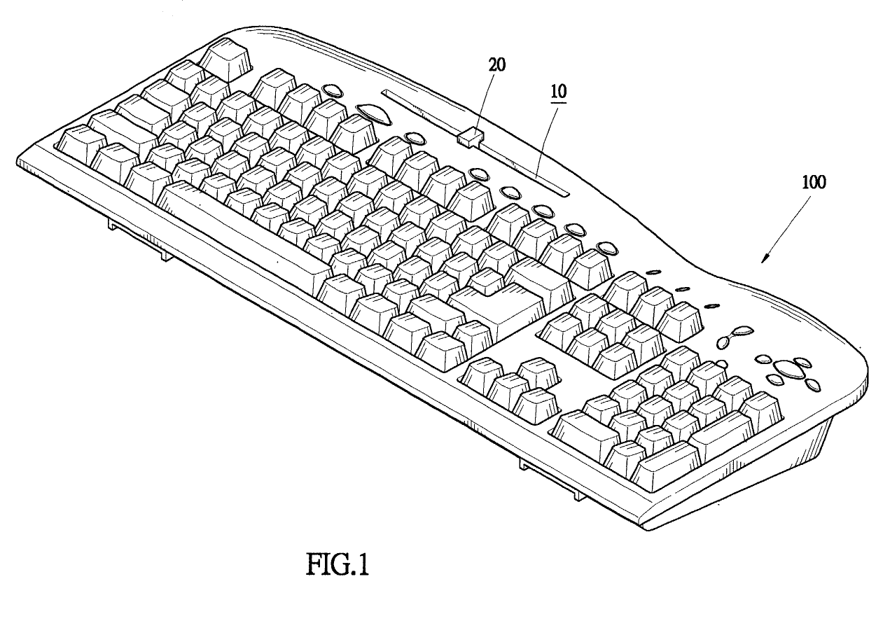

Referring to FIG. 1, the keyboard with track operation key in this invention includes a keyboard 100. At a proper position of the keyboard 100 has a track 10, set on the top of the keyboard 100 horizontally. In the track 10, there is an operation key(20) which can move along the track 10. In the track 10, there is a sensor ( not shown in FIG. 1) used to detect the displacement value of the operation key 20 moving in the track 10, and then convert to the displacement that can control the cursor movement on the screen. In this embodiment, the operation key 20 moves horizontally to operate the displacement of the cursor horizontally. It's possible to convert the horizontal movement of the operation key 20 into a vertical movement, but that is not so smoothly on the operation.

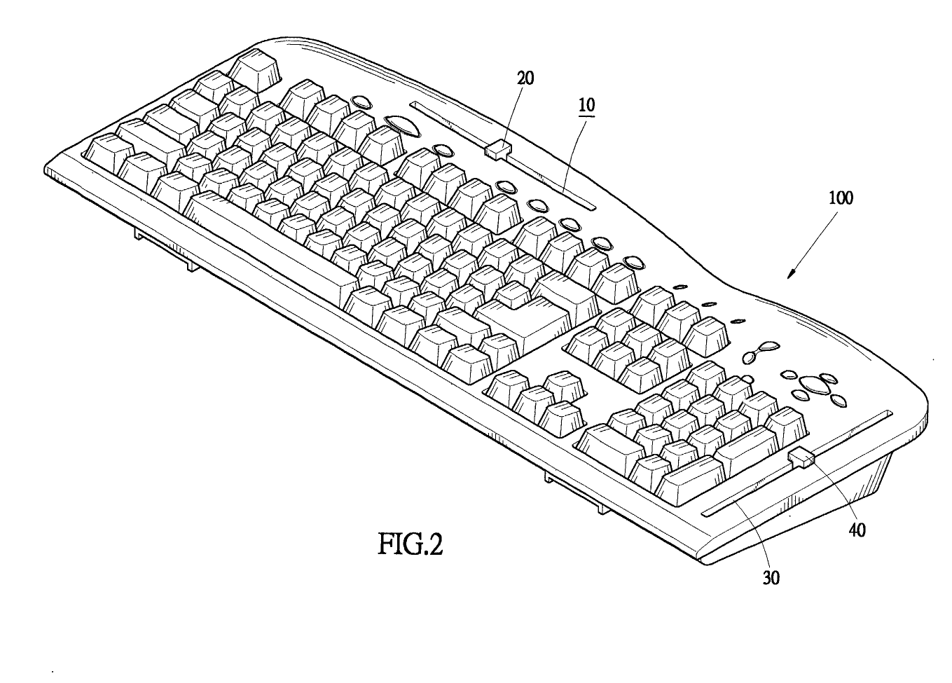

Referring to FIG. 2, another embodiment of this invention has a vertical track 30 and an operation key 40. It will be more proper to operate the vertical movement through the track 30 and the operation key 40. Of course, it will be even more useful that the horizontal track 10 and the operation key 20 can be located on the top of the keyboard 100 and the vertical track 30 and the operation key 40 located on side of the keyboard 100 simultaneously to operate the moving of the cursor horizontally and vertically.

When the operation key moves to a particular position, we can use another control key, or design the control key in the operation key to set the position.

For sensing and converting the operation keys 20, 40 in order to convert the displacement of the operation keys 20, 40 into cursor movement are known to people who are familiar in the art, which is not the feature of this invention, so that no further description will be presented in this speicfication.

What is claimed is:

1. A keyboards with a track operation key, comprising a track located at a proper position on the keyboard, an operation key located in the track and moving along the track, a sensor located in the track to detect the motion of the operation key and to convert the motion into a displacement value to control the cursor movement.

2. A keyboards with a track operation key as claimed in claim 1, the track and the operation key are horizontally located in the keyboard.

3. A keyboards with a track operation key as claimed in claim 1, the track and the operation key implemented are vertically located in the keyboard.
